(19) United States
(12) Patent Application Publication
(10) Pub. No.: US 2016/0234864 A1
(43) Pub. Date: Aug. 11, 2016

(54) Method and Device for Processing Random Access Preamble

(71) Applicant: ZTE CORPORATION, Shenzhen (CN)

(72) Inventors: Qi GUO, Shenzhen (CN); Meiling DING, Shenzhen (CN); Bin LI, Shenzhen (CN)

(21) Appl. No.: 14/442,469

(22) PCT Filed: Aug. 14, 2013
(86) PCT No.: PCT/CN2013/081475

§ 371 Date: May 13, 2015

(30) Foreign Application Priority Data
Dec. 28, 2012 (CN) 201210584593.1

(51) Int. Cl. H04W 74/08; H04W 74/00; H04W 72/04

(52) U.S. Cl. CPC H04W 74/0833; H04W 72/0446; H04W 74/004

(57) ABSTRACT

The disclosure provides a method and device for processing a random access preamble. The method includes: determining a Guard Time (GT) required by communication between a User Equipment (UE) and a base station according to a cell coverage radius, wherein the cell coverage radius is larger than 100 kilometers; and determining the random access preamble transmitted by the UE to the base station according to the GT, wherein the random access preamble is transmitted on an ordinary sub-frame in a radio frame during the communication between the UE and the base station. By the method and the device, the problem that the cell coverage radius of a single station cannot exceed 100 kilometers in a related technology is solved, and effects of enlarging the cell coverage radius of the single station and meeting a requirement on an ultra-large cell coverage radius in a special scenario are further achieved.

### TECHNICAL FIELD

The disclosure relates to the field of communication, including e.g., a method and device for processing a random access preamble.

### BACKGROUND

As one of the 4th Generation (4G) mobile communication technologies and standards, Time Division-Long Term Evolution (TD-LTE) has technical advantages in multiple fields of rate, delay, spectrum utilization and the like, so that a stronger service can be provided on a finite spectral bandwidth resource.

TD-LTE service and application are extended to more and more fields. For example, a single station is usually required to have a sufficient cell coverage radius under a special scenario such as air route or sea surface to reduce the requirement of the resource on the station deployment and relieve the pressure caused by difficulties in finding a station location. As a result, the single station is required to realize a cell coverage radius of more than 100 kilometers and even 200 kilometers under a directional antenna configuration in a air route coverage scenario.

TD-LTE is a time-division duplex system, and its 10 ms radio frame includes an ordinary sub-frame and a special sub-frame. An uplink and downlink time slot allocation proportion supported by the TD-LTE frame is as shown in Table 1.

TABLE 1
Uplink and downlink time slot allocation of TD-LTE system

| Allocation | | | | | | | | | | | |
|---|---|---|---|---|---|---|---|---|---|---|---|
| configuration | Downlink- | | | | | | | | | | |
| of downlink- | uplink | | | | | | | | | | |
| uplink | switching | Sub-frame number | | | | | | | | | |
| sub-frames | period | 0 | 1 | 2 | 3 | 4 | 5 | 6 | 7 | 8 | 9 |
| DL/UL = 1/3 | 5 ms | D | S | U | U | U | D | S | U | U | U |
| DL/UL = 2/2 | 5 ms | D | S | U | U | D | D | S | U | U | D |
| DL/UL = 3/1 | 5 ms | D | S | U | D | D | D | S | U | D | D |
| DL/UL = 6/3 | 10 ms | D | S | U | U | U | D | D | D | D | D |
| DL/UL = 7/2 | 10 ms | D | S | U | U | D | D | D | D | D | D |
| DL/UL = 8/1 | 10 ms | D | S | U | D | D | D | D | D | D | D |
| DL/UL = 3/5 | 5 ms | D | S | U | U | U | D | S | U | U | D |

The special sub-frame consists of three special time slots: a Downlink Pilot Time Slot (DwPTS), a Guard Period (GP) and an Uplink Pilot Time Slot (UpPTS). Wherein, the GP reserves a two-way transmission delay for uplink and downlink data, and is one of important factors for determining the cell radius. A time slot structure of the special sub-frame of TD-LTE is as shown in Table 2.

TABLE 2
Time slot structure of special sub-frame of TD-LTE system

| Configuration of | Normal cyclic prefix | | | Extended cyclic prefix | | |
|---|---|---|---|---|---|---|
| special sub-frame | DwPTS | GP | UpPTS | DwPTS | GP | UpPTS |
| 0 | 3 | 10 | 1 | 3 | 8 | 1 |
| 1 | 9 | 4 | OFDM | 8 | 3 | OFDM |
| 2 | 10 | 3 | symbols | 9 | 2 | symbols |
| 3 | 11 | 2 | | 10 | 1 | |
| 4 | 12 | 1 | | 3 | 7 | 2 |
| 5 | 3 | 9 | 2 | 8 | 2 | OFDM |
| 6 | 9 | 3 | OFDM | 9 | 1 | symbols |
| 7 | 10 | 2 | symbols | — | — | — |
| 8 | 11 | 1 | | — | — | — |

Each cell radius under a bandwidth of 20 MHz can be calculated according to the length of the GP under different configurations. The corresponding cell radiuses under the bandwidth of 20 MHz are as shown in Table 3, wherein Tₛ is a time unit, and 30,720 Tₛ=1 ms.

TABLE 3
Cell radius corresponding to each special sub-frame of TD-LTE
system under bandwidth of 20 MHz

| Configuration | Normal cyclic prefix | | Extended cyclic prefix | |
|---|---|---|---|---|
| of special | GP | Cell radius | GP | Cell radius |
| sub-frame | (Tₛ) | (km) | (Tₛ) | (km) |
| 0 | 21,936Tₛ | 107.1094 | 20,480Tₛ | 100 |
| 1 | 8,768Tₛ | 42.8125 | 7,680Tₛ | 37.5 |
| 2 | 6,576Tₛ | 32.10938 | 5,120Tₛ | 25 |
| 3 | 4,384Tₛ | 21.40625 | 2,560Tₛ | 12.5 |
| 4 | 2,192Tₛ | 10.70313 | 17,920Tₛ | 87.5 |
| 5 | 19,744Tₛ | 96.40625 | 5,120Tₛ | 25 |
| 6 | 6,576Tₛ | 32.10938 | 2,560Tₛ | 12.5 |
| 7 | 4,384Tₛ | 21.40625 | | |
| 8 | 2,192Tₛ | 10.70313 | | |

In addition, a random access preamble structure of the TD-LTE system also plays a decisive role in the cell radius. The preamble includes a Cyclic Prefix (CP) with a length T_{CP}, a random access preamble Sequence (Seq) with a length T_{SEQ} and a Guard Time (GT) part. FIG. 1 is a diagram of the random access preamble structure of the TD-LTE system according to a related technology, and as shown in FIG. 1, five preamble structures of the TD-LTE system are defined in a protocol, and a maximum cell radius supportable for each preamble is as shown in Table 4.

TABLE 4
Maximum cell radiuses supportable for 5 different preambles in TD-LTE
system

| Configuration | | | | |
|---|---|---|---|---|
| of random | | | | |
| access preamble | T_{CP} | T_{SEQ} | T_{GT} | Cell radius |
| Format 0 | 3,168Tₛ | 24,576Tₛ | 2,976Tₛ | 14.5 km |
| Format 1 | 21,024Tₛ | 24,576Tₛ | 15,840Tₛ | 77 km |
| Format 2 | 6,240Tₛ | 2 * 24,576Tₛ | 6,048Tₛ | 30 km |
| Format 3 | 21,024Tₛ | 2 * 24,576Tₛ | 21,984Tₛ | 100 km |
| Format 4* | 448Tₛ | 4,096Tₛ | 614Tₛ | 3 km |

It can thus be seen that a maximum cell coverage radius of only 100 kilometers can be realized in the TD-LTED system in the related technology. In order to realize a larger cell coverage radius of the single station, the TD-LTE system requires corresponding configuration and design transformation.

Therefore, the problem that the cell coverage radius of the single station cannot exceed 100 kilometers exists in the related technology.

### SUMMARY

A method and device for processing a random access preamble is provided, so as to solve the problem that a cell coverage radius of a single station cannot exceed 100 kilometers in the related technology.

According to one aspect of the disclosure, a method for processing a random access preamble is provided, comprising: determining a GT required by communication between a User Equipment (UE) and a base station according to a cell coverage radius, wherein the cell coverage radius is larger than 100 kilometers; and determining the random access preamble transmitted by the UE to the base station according to the GT, wherein the random access preamble is transmitted on an ordinary sub-frame in a radio frame during the communication between the UE and the base station.

According to an embodiment of the disclosure, before determining the random access preamble transmitted by the UE to the base station according to the GT, the method further comprising: determining a Guard Period GP required by the communication between the UE and the base station according to the cell coverage radius.

According to an embodiment of the disclosure, determining the random access preamble transmitted by the UE to the base station according to the GT comprises: regulating lengths of a random access preamble sequence part and a GT part in the random access preamble of the radio frame, wherein a regulated length of the GT part is not smaller than that of the GT determined according to the cell coverage radius.

According to an embodiment of the disclosure, after determining the random access preamble transmitted by the UE to the base station according to the GT, the method further comprising: judging whether a uplink time slot resource in a communication resource for the communication between the UE and the base station is sufficient for transmitting the random access preamble by the UE to the base station or not; and based on that a judgment result is negative, regulating the allocation of uplink and downlink time slot resources of the communication resource.

According to an embodiment of the disclosure, the length of the GP is ranged from a length of ⅔ of a sub-frame to a length of 2 sub-frames.

According to the other aspect of the disclosure, a device for processing a random access preamble is provided, comprising: a first determining component, configured to determine a Guard Time GT required by communication between a UE and a base station according to a cell coverage radius, wherein the cell coverage radius is larger than 100 kilometers; and a second determining component, configured to determine the random access preamble transmitted by the UE to the base station according to the GT, wherein the random access preamble is transmitted on an ordinary sub-frame in a radio frame during the communication between the UE and the base station.

According to an embodiment of the disclosure, the device further comprises: a third determining component, configured to determine a Guard Period GP required by the communication between the UE and the base station according to the cell coverage radius.

According to an embodiment of the disclosure, the second determining component comprises: a regulating unit, configured to regulate lengths of a random access preamble sequence part and a GT part in the random access preamble of the radio frame, wherein a regulated length of the GT part is not smaller than that of the GT determined according to the cell coverage radius.

According to an embodiment of the disclosure, the device further comprises: a judging component, configured to judge whether a uplink time slot resource in a communication resource for the communication between the UE and the base station is sufficient for transmitting the random access preamble by the UE to the base station or not; and a regulating component, configured to, based on that a judgment result of the judging component is negative, regulate the allocation of uplink and downlink time slot resources of the communication resource.

According to an embodiment of the disclosure, the third determining component is further configured to determine that the length of the GP is ranged from a length of ⅔ of a sub-frame to a length of 2 sub-frames.

By the disclosure, the GT required by the communication between the UE and the base station is determined according to the cell coverage radius, wherein the cell coverage radius is larger than 100 kilometers; and the random access preamble transmitted by the UE to the base station is determined according to the GT, wherein the random access preamble is transmitted on the ordinary sub-frame in the radio frame during the communication between the UE and the base station, so that the problem that the cell coverage radius of the single station cannot exceed 100 kilometers in the related technology is solved, and effects of enlarging the cell coverage radius of the single station and meeting a requirement on an ultra-large cell coverage radius in a special scenario are further achieved.

### BRIEF DESCRIPTION OF THE DRAWINGS

The drawings are described here to provide further understanding of the disclosure, and form a part of the disclosure. The schematic embodiments and description of the disclosure are adopted to explain the disclosure, and do not form improper limits to the disclosure. In the drawings:

FIG. 1 is a diagram of a random access preamble structure of a TD-LTE system according to a related technology;

FIG. 2 is a flowchart of a method for processing a random access preamble according to an embodiment of the disclosure;

FIG. 3 is a structure diagram of a device for processing a random access preamble according to an embodiment of the disclosure;

FIG. 4 is a first preferred structure diagram of a device for processing a random access preamble according to an embodiment of the disclosure;

FIG. 5 is a preferred structure diagram of a first determining component 32 of a device for processing a random access preamble according to an embodiment of the disclosure;

FIG. 6 is a second preferred structure diagram of a device for processing a random access preamble according to an embodiment of the disclosure;

FIG. 7 is a structure diagram of a device for configuring a random access preamble for an ultra-large radius cell of a TD-LTE system according to a preferred embodiment of the disclosure;

FIG. 8 is a flowchart of implementation of a method for configuring a random access preamble for an ultra-large radius cell according to a preferred embodiment of the disclosure;

FIG. 9 is a diagram of a random access preamble for a 200 km-radius cell of a TD-LTE system according to an embodiment of the disclosure;

FIG. 10 is a sequence diagram of a frame structure for a 200 km-radius cell of a TD-LTE system according to an embodiment of the disclosure.

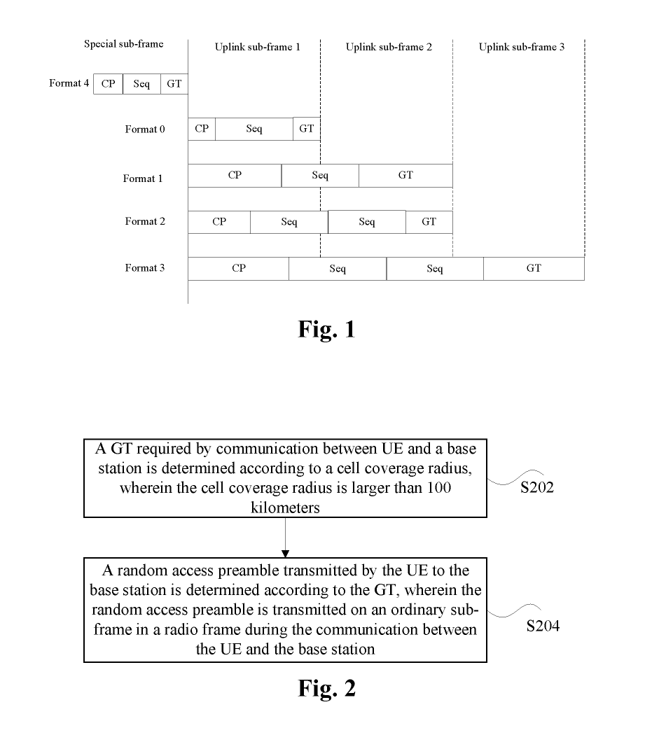

### DETAILED DESCRIPTION OF THE EMBODIMENTS

It is noted that the embodiments of the disclosure and the characteristics in the embodiments can be combined if there is no conflict. The disclosure is described below with reference to the drawings and embodiments in detail.

A method for processing a random access preamble is provided in the embodiment of the disclosure, and FIG. 2 is the flowchart of the method for processing the random access preamble according to the embodiment of the disclosure, as shown in FIG. 2, the method comprises:

Step 202, A Guard Time GT required by the communication between a UE and a base station is determined according to a cell coverage radius, wherein the cell coverage radius is larger than 100 kilometers; and

Step 204, A random access preamble transmitted by the UE to the base station is determined according to the GT, wherein the random access preamble is transmitted on an ordinary sub-frame in a radio frame during the communication between the UE and the base station.

By the steps above, the GT required by the communication between the UE and the base station is determined according to the cell coverage radius, the cell coverage radius being larger than 100 kilometers; and the random access preamble transmitted by the UE to the base station is determined according to the GT, wherein the random access preamble is transmitted on the ordinary sub-frame in the radio frame during the communication between the UE and the base station. The length of the GT is extended according to a required cell coverage radius, and the random access preamble is carried in an uplink sub-frame (i.e. an uplink time slot resource for transmitting data by the UE to the base station) of the ordinary sub-frame for transmission, namely the structure of the random access preamble is changed, so that the problem that the cell coverage radius of the single station cannot exceed 100 kilometers in the related technology is solved, and effects of enlarging the cell coverage radius of the single station and meeting the requirement on the ultra-large cell coverage radius in the special scenario are further achieved.

Before the random access preamble transmitted by the UE to the base station is determined according to the GT, the method further comprises: a GP required by the communication between the UE and the base station is determined according to the cell coverage radius. Preferably, the length of the GP is ranged from a length of ⅔ of a sub-frame to a length of 2 sub-frames. The GP is in a special sub-frame, so that the length of the special sub-frame should be correspondingly changed based on that the length of the GP is changed. By adopting the method, the GP in the special sub-frame is extended according to the required cell coverage radius, so that the interference between uplink data and downlink data is favorably prevented on the premise that the cell coverage of the single station meets a requirement of the special scenario.

According to an embodiment of the disclosure, determining the random access preamble transmitted by the UE to the base station according to the GT comprises: lengths of a random access preamble sequence part and a GT part in the random access preamble of the radio frame are regulated, wherein the regulated length of the GT part is not smaller than that of the GT determined according to the cell coverage radius. For example, in the configuration of Format 3 of the random access preamble of the TD-LTE frame (see Table 4), the random access preamble sequence comprises two sequences with lengths of 24,576 Tₛ and the latter (adjacent to the GT part) in the two sequences is regulated to be the GT, so that the extension of the GT in the random access preamble is implemented, namely by transforming the structure of the random access preamble. After the GT is extended, the length of the random access preamble is a length of three sub-frames, and under the condition, the random access preamble can be only transmitted on the three continuous uplink sub-frames after the special sub-frame. By adopting the method, a utilization rate of a conventional time slot is increased to a certain extent. It is noted that the length of the random access preamble sequence part can be regulated in multiple ways, for example: the length of the previous sequence can also be decreased without changing the next sequence. After the random access preamble sequence is correspondingly regulated, an access process of the UE can also be implemented only by correspondingly regulating a receiving algorithm of a receiving end.

In order to ensure the transmission of the random access preamble, after the random access preamble transmitted by the UE to the base station is determined according to the GT, whether a uplink time slot resource in a communication resource for the communication between the UE and the base station is sufficient for transmitting the random access preamble by the UE to the base station or not can be judged at first; and based on that a judgment result is negative, the allocation of uplink and downlink time slot resources of the communication resource is regulated. For example, when the uplink-downlink time slot allocation of DL/UL=6/3 of the sub-frames shown in Table 1, and the random access preamble configuration of Format 3 in Table 4 are adopted in the radio frame, along with the extension of the GP, the length of the special sub-frame may be extended into a length of two sub-frames, namely sub-frames 1 and 2 in Table 1 are special sub-frames, and the sub-frame 6 is required to be regulated into an uplink sub-frame (that is, the downlink time slot resource is regulated into the uplink time slot resource) to ensure a sufficient uplink time slot for the transmission of the random access preamble with the length of three sub-frames. Regulation processes of the allocation configuration of other time slots are similar to the above-mentioned regulation process. In such a way, the adaptive successful transmission of the random access preamble is ensured.

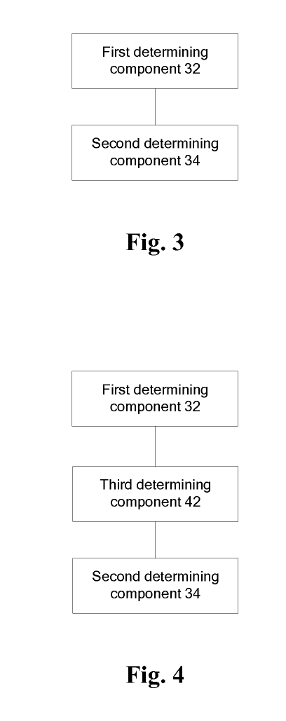

FIG. 3 is the structure diagram of the device for processing the random access preamble according to the embodiment of the disclosure, as shown in FIG. 3, the device comprises: a first determining component 32 and a second determining component 34. The device is described below.

The first determining component 32 is configured to determine a GT required by communication between a UE and a base station according to a cell coverage radius, wherein the cell coverage radius is larger than 100 kilometers; and the second determining component, connected to the first determining component 32, is configured to determine the random access preamble transmitted by the UE to the base station according to the GT, wherein the random access preamble is transmitted on an ordinary sub-frame in a radio frame during the communication between the UE and the base station.

FIG. 4 is the first preferred structure diagram of the device for processing the random access preamble according to the embodiment of the disclosure, as shown in FIG. 4, besides all the components in FIG. 3, the preferred structure further comprises a third determining component 42, connected to the first determining component 32 and the second determining component 34, is configured to determine a GP required by the communication between the UE and the base station.

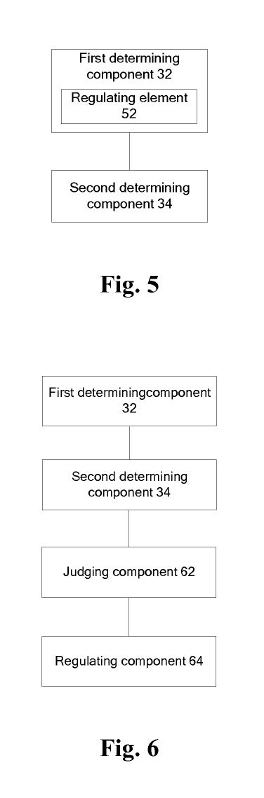

FIG. 5 is the preferred structure diagram of the first determining component 32 of the device for processing the random access preamble according to the embodiment of the disclosure, as shown in FIG. 5, the first determining component 32 comprises a regulating element 52, is configured to regulate lengths of a random access preamble sequence part and a GT part in the random access preamble of the radio frame, wherein the regulated length of the GT part is not smaller than that of the GT determined according to the cell coverage radius.

FIG. 6 is the second preferred structure diagram of the device for processing the random access preamble according to the embodiment of the disclosure, as shown in FIG. 6, besides all the components in FIG. 3, the preferred structure further comprises a judging component 62 and a regulating component 64. The preferred structure is described below.

The judging component 62, connected to the second determining component 34, is configured to judge whether a uplink time slot resource in a communication resource for the communication between the UE and the base station is sufficient for transmitting the random access preamble by the UE to the base station or not; and the regulating component 64, connected to the judging component 62, is configured to, based on that a judgment result of the judging component 62 is negative, regulate the allocation of uplink and downlink time slot resources of the communication resource.

According to an embodiment of the disclosure, the third determining component 42 is further configured to determine that the length of the GP is ranged from a length of ⅔ of a sub-frame to a length of 2 sub-frames.

It is noted that the steps shown in the flowcharts in the drawings can be executed in a computer system, for example, a group of computers, capable of executing an instruction, and moreover, although a logic sequence is shown in the flowcharts, the shown or described steps can be executed according to a sequence different from the logic sequence under a certain condition. Specific implementation processes, corresponding to the abovementioned method embodiments, described in the device embodiments have been described in detail in the method embodiments, and are not be repeated here.

In order to make the technical solution of the disclosure and the implementation method clearer, the implementation process is described below with reference to the preferred embodiments in detail.

The base station communicates with the UE through the radio frame, wherein the length of the random access preamble of the radio frame is the length of three sub-frames, the random access preamble includes the GT with an extended length, and the special sub-frame of the radio frame includes the GP with an extended length. Preferably, the length of the GT is more than that of ¾ of a sub-frame, and the length of the GP is more than that of ⅔ of a sub-frame.

According to an embodiment of the disclosure, the random access preamble comprises: a cyclic prefix, a random access preamble sequence and a GT, wherein, under the bandwidth of 20 MHz, the length of the cyclic prefix is 21,024 Tₛ, the length of the random access preamble sequence is 24,576 Tₛ, the length of the GT is 46,560 Tₛ, the length of a sub-frame is 30,720 Tₛ, Tₛ is a time unit, and 30,720 Tₛ=1 ms. The length of the GP in the special sub-frame is more than 20,480 Tₛ.

Preferably, the random access preamble of the radio frame is transmitted on three continuous uplink sub-frames.

The method and device for configuring the frame for the ultra-large-radius cell provided by the embodiments and preferred embodiments can ensure that the cell coverage radius of a single TD-LTE base station is extended from 100 kilometers restricted in the protocol to 200 kilometers and even larger. Specifically:

in the preferred embodiment, configuring and modifying the frame structure of the TD-LTE system according to the target cell coverage radius comprises:

a GP extension step, is configured to calculate a required GP according to the target cell coverage radius and extend the GP of the TD-LTE system to 1˜2 sub-frames according to needs to prevent downlink data from the interference of uplink data of a large-radius cell system;

a cell random access preamble transformation step, is configured to transform the format of the random access preamble according to the target cell coverage radius to prevent the downlink data from the interference of the random access preamble required by the large-radius cell system; and

a cell random access preamble transmission time sequence regulation step, is configured to transform the structure of the radio frame and regulate the time sequence of the cell random access preamble in combination with a GP configuration and a random access preamble requirement to meet two-way transmission requirements of an edge user of a large-radius cell and avoid the interference of the uplink and downlink data in the system.

The configuration of the abovementioned three is described below.

The GP extension step specifically comprises: the required GP is calculated according to a required coverage radius of the target cell, and the GP of the TD-LTE system is extended to 1˜2 sub-frames according to needs. For a large-radius cell of which the target cell coverage radius is required to be extended to 200 kilometers, the time slot of the special sub-frame with the GP is required to be extended to 2 sub-frames.

The cell random access preamble transformation step is configured to transform the format of the random access preamble according to the target cell coverage radius to prevent the downlink data from the interference of the random access preamble sequence required by the large-radius cell system, specifically comprises:

Step 1: the configuration of the random access preamble for the cell is selected with reference to the maximum cell radiuses supportable for the 5 preambles in the TD-LTED system in Table 4 according to the target cell coverage radius. For the condition that the radius of the large-radius cell is required to be more than 100 kilometers, the random access preamble for the cell is at least required to be configured into Format 3;

Step 2: the GT of the required random access preamble is calculated according to the target cell coverage radius. For the GT of the random access preamble, a two-way delay interval from the base station to a terminal is required to be protected; and

Step 3: the second SEQ of the cell random access preamble is transformed into the GT part to enable the transformed GT part of the random access preamble to meet the requirement that the radius of the large-radius cell is more than 100 kilometers.

The cell random access preamble transmission time sequence regulation step is configured to transform the structure of the radio frame and regulate the time sequence of the cell random access preamble in combination with the GT configuration and the random access preamble requirement to meet the two-way transmission requirements of the edge user of the large-radius cell and avoid the interference of the uplink and downlink data in the system, specifically comprises:

Step a, the time slot of the special sub-frame is regulated to enable the GP to meet the large cell radius requirement, and a DwPTS and an UpPTS are configured according to the needs;

Step b, if there is no sufficient uplink sub-frames in the transformed radio frame, the corresponding downlink sub-frames is regulated into uplink sub-frames to ensure that there are sufficient uplink sub-frames in the radio frame for the terminal side to transmit the cell random access preamble; and

Step c, the transmission time sequence of the random access preamble is regulated.

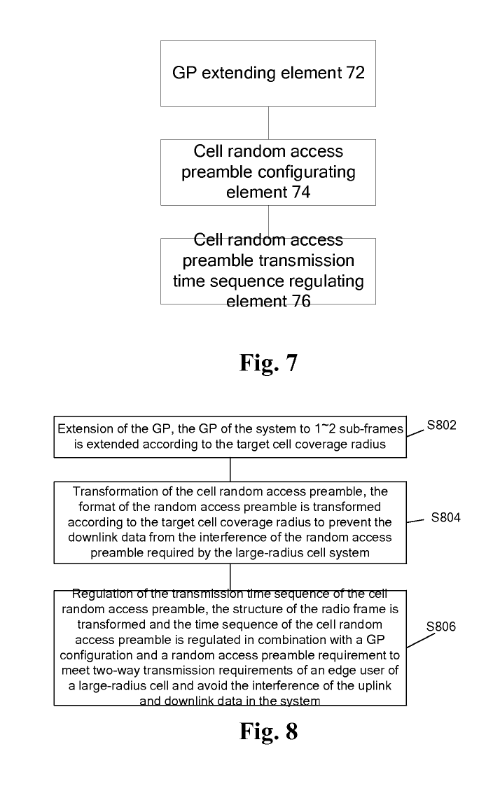

FIG. 7 is the structure diagram of the device for configuring the random access preamble for the ultra-large radius cell of the TD-LTE system according to the preferred embodiment of the disclosure, as shown in FIG. 7, the system comprises: a GP extending element 72, a cell random access preamble configuring element 74 and a cell random access Preamble transmission time sequence regulating element 76. The system is described below.

The GP extending element 72 is configured to calculate a required GP according to a target cell coverage radius and extend the GP of the TD-LTE system to 1˜2 sub-frames to prevent downlink data from the interference of uplink data of a large-radius cell system;

the cell random access preamble transformation unit 74 is configured to transform the format of the random access preamble according to the target cell coverage radius to prevent the downlink data from the interference of the random access preamble required by the large-radius cell system; and

the cell random access Preamble transmission time sequence regulating element 76 is connected to the GP extending element 72 and the cell random access preamble configuring element 74, is configured to transform the structure of the radio frame and regulate the time sequence of the cell random access preamble in combination with a GP configuration and a random access preamble requirement to meet two-way transmission requirements of an edge user of a large-radius cell and avoid the interference of the uplink and downlink data in the system.

Compared with the related art, the disclosure, by extending the GP, transforming the cell random access preamble and regulating the transmission time sequence of the random access preamble, brings the advantages that a bottleneck of single-cell coverage radius of 100 kilometers of the TD-LTE system is broken, a wider cell coverage is realized, and the application of the TD-LTE system to an ultra-large cell coverage scenario (200 kilometers or more than 200 kilometers) such as a air route coverage, a sea surface and a grassland is extended.

The method for configuring the frame of the ultra-large radius cell (or called an ultra-large cell coverage) of the TD-LTE system provided by the embodiment of the disclosure is adopted to realize the ultra-large cell coverage radius of the TD-LTE system. In order to better understand the technical solution in the embodiment of the disclosure, the realization of a 200 kilometer-radius cell of the TD-LTE system is taken as an example for description with reference to the drawings.

FIG. 8 is the flowchart of implementation of the method for configuring the random access preamble for the ultra-large radius cell according to the preferred embodiment of the disclosure, as shown in FIG. 8, the flow comprises:

Step 802, the GP is extended, which is adopted to calculate the required GP according to the target cell coverage radius and extend the GP of the TD-LTE system to 1˜2 sub-frames to prevent downlink data from the interference of uplink data of the large-radius cell system.

Under the condition that the target cell coverage radius is r=200 km, the speed of light is c=3×10⁸ m/s, and the required GP is represented as T_{GP}, the required GP is specifically that:

$${T}_{GP} = \frac{200 km}{3 \times {10}^{8} m \text{/} s} \times 2 = 1.33 ms ;$$

As shown in Table 5, under the bandwidth of 20 MHz, the sampling frequency of the system is 30.72 MHz, and the GP required by the 200 kilometer-radius cell is required to occupy:

1.33 ms×30.72 MHz=40,960 Tₛ.

TABLE 5
bandwidth allocation and sampling frequency of TD-LTE

| | System bandwidth | | | | | |
|---|---|---|---|---|---|---|
| | 1.4 MHz | 3 MHz | 5 MHz | 10 MHz | 15 MHz | 20 MHz |
| Sampling | 1.92 | 3.84 | 7.68 | 15.36 | 23.04 | 30.72 |
| frequency | | | | | | |
| (MHz) | | | | | | |

The GP required by the 200 kilometer-radius cell is required to occupy 40,960 Ts, namely the GP in the special sub-frame of the TD-LTE radio frame at least is required 40,960 Ts.

It follows that the length of the sub-frame under the bandwidth configuration of 20 MHz is 30720 Ts. For the condition that the GP is at least 40,960 Tₛ, the special sub-frame with the GP is required to extend to two sub-frames.

Step 804, The cell random access preamble is transformed, which is adopted to transform the format of the random access preamble according to the target cell coverage radius to prevent the downlink data from the interference of the random access preamble required by the large-radius cell system, specifically comprises:

Step A, Under the condition that the target cell coverage radius is required to 200 kilometers, namely it is more than 100 kilometers, the format of the cell random access preamble is configured at least to Format 3 according to the maximum cell radiuses supportable for the five different preambles in the TD-LTE system as shown in Table 4. As shown in Table 6, the scheme design is described by taking the preamble configuration Format 3 as an example.

TABLE 6
Maximum supportable cell radiuses in preamble
format 3 in TD-LTE system

| Random access | | | | |
|---|---|---|---|---|
| preamble configuration | T_{CP} | T_{SEQ} | T_{GT} | Cell radius |
| 3 | 21024Ts | 2 * 24576Ts | 21984Ts | 100 km |

Step B, the GT of the required random access preamble is calculated according to the target cell coverage radius. For the GT of the preamble sequence, the two-way delay interval from the base station to the terminal is required to be protected. The terminal does not know its distance with the base station when transmitting the preamble, so that the length of the GT must be sufficient for the terminal at the edge of the cell, to prevent the subsequent signal reception of the base station from the interference caused by the random access preamble transmitted according to a primarily found timing position of the cell.

Under the condition that the target cell coverage radius is r=200 km, the speed of light is c=3×10⁸ m/s, and the required GT of the random access preamble is represented as T_{GT}, under the bandwidth of 20 MHz, the required GT is specifically:

$${T}_{GT} = \frac{200 km}{3 \times {10}^{8} m \text{/} s} \times 2 = 40960 Ts$$

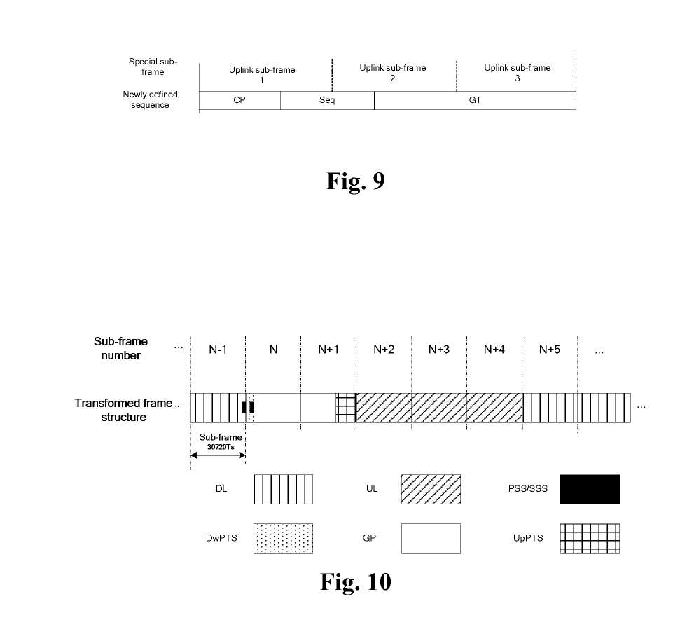

Step C, FIG. 9 is the diagram of the random access preamble for the 200 km-radius cell of the TD-LTE system according to the embodiment of the disclosure, as shown in FIG. 9, the second SEQ of the cell random access preamble is transformed into the GT part to enable the transformed GT part of the random access preamble to meet the requirement that the radius of the large-radius cell is more than 100 kilometers. The transformed preamble requires the cooperation of a receiving algorithm of a base station side to ensure access performance. After the second SEQ is transformed into the GT part, the total length of the transformed GT is 24,576 Tₛ+21,984 Tₛ=46,560 Tₛ. From the above analysis, the requirement that the length of the GT of the preamble is 40,960 Tₛ under the condition of 200 kilometers can be met. Therefore, the transformed preamble sequence can meet a requirement on the access performance of the UE at the edge of the 200 kilometer-radius cell. Three continuous uplink sub-frames are required to be occupied for the transmission of the random access preamble.

Step 806, the transmission time sequence of the cell random access preamble is regulated, which is adopted to transform the structure of the radio frame and regulate the time sequence of the cell random access preamble in combination with the GT configuration and the random access preamble requirement to meet the two-way transmission requirements of the edge user of the large-radius cell and avoid the interference of the uplink and downlink data in the system, specifically including that:

in accordance with the above analysis and the configuration of the embodiment, in order to meet the requirement that the cell coverage of the TD-LTE is 200 kilometers, the GP of the special sub-frame is required to be extended to 40,960 Tₛ under the condition that the bandwidth is 20 MHz and the ordinary cyclic prefix is configured, and three uplink sub-frames are required to be occupied for the transmission of the cell random access preamble. Therefore, the conventional TD-LTE radio frame is correspondingly transformed, specifically by:

Step A, the time slot of the special sub-frame is regulated to enable the GP to meet the large cell radius requirement.

According to the above calculation, the length of the GP is at least required 40,960 Tₛ under the condition that the cell radius is 200 kilometers. Therefore, the special sub-frame with the GP is required to be extended to 2 sub-frames. The configuration of the DwPTS and the UpPTS is regulated according to the GP; and the total length of the two sub-frames is 2*30,720 Tₛ, namely 61,440 Tₛ. Wherein, 40,960 Tₛ serves as the GP, and 61,440 Tₛ−40,960 Tₛ=20,480 Tₛ serves as the DwPTS and the UpPTS. Wherein, time lengths of the DwPTS and the UpPTS can be flexibly configured according to the conditions of the cell. Therefore, the requirement of the GP required by the 200 kilometer-radius cell has been met.

Step B, base on that there is not sufficient uplink sub-frames for the transformed radio frame, the corresponding downlink sub-frames is regulated into uplink sub-frames to ensure that there are sufficient uplink sub-frames in the radio frame for the terminal side to transmit the cell random access preamble; and

after the special sub-frame is extended to two sub-frames, whether there are sufficient uplink sub-frames for the transmission of the random access preamble or not is judged. According to the above analysis, three continuous uplink sub-frames are required to be occupied on a time domain for the random access preamble required by the 200 kilometer-radius cell. In the embodiment, three continuous sub-frames after a new special sub-frame are regulated into three continuous uplink sub-frames according to the following design.

Step C, the transmission time sequence of the random access preamble is regulated. The transformed random access preamble can be transmitted in the positions of the transformed three continuous uplink sub-frames.

FIG. 10 is the time sequence diagram of the frame structure for the 200 km-radius cell of the TD-LTE system according to the embodiment of the disclosure, as shown in FIG. 10, the frame structure for the cell transformed by the above-mentioned transformation meet the coverage radius of 200 kilometers.

Obviously, those skilled in the field should know that each component or step of the disclosure can be implemented by a universal computing device, and the components or steps can be concentrated on a single computing device or distributed on a network formed by a plurality of computing devices, and can optionally be implemented by programmable codes executable for the computing devices, so that the components or steps can be stored in a storage device for execution with the computing devices, or can form each integrated circuit component, or multiple components or steps therein can form a single integrated circuit component for implementation. As a consequence, the disclosure is not limited to any specific hardware and software combination.

The above is only the preferred embodiments of the disclosure and not intended to limit the disclosure, and for the technician of the field, the disclosure can have various modifications and variations. Any modifications, equivalent replacements, improvements and the like within the spirit and principle of the disclosure shall fall within the scope of protection of the disclosure.

1. A method for processing a random access preamble, comprising:
determining a Guard Time (GT) required by communication between a User Equipment (UE) and a base station according to a cell coverage radius, wherein the cell coverage radius is larger than 100 kilometers; and
determining the random access preamble transmitted by the UE to the base station according to the GT, wherein the random access preamble is transmitted on an ordinary sub-frame in a radio frame during the communication between the UE and the base station.

2. The method according to claim 1, before determining the random access preamble transmitted by the UE to the base station according to the GT, further comprising:
determining a Guard Period (GP) required by the communication between the UE and the base station according to the cell coverage radius.

3. The method according to claim 1, wherein determining the random access preamble transmitted by the UE to the base station according to the GT comprises:
regulating lengths of a random access preamble sequence part and a GT part in the random access preamble of the radio frame, wherein a regulated length of the GT part is not smaller than that of the GT determined according to the cell coverage radius.

4. The method according to claim 1, after determining the random access preamble transmitted by the UE to the base station according to the GT, further comprising:
judging whether a uplink time slot resource in a communication resource for the communication between the UE and the base station is sufficient for transmitting the random access preamble by the UE to the base station or not; and
based on that a judgment result is negative, regulating the allocation of uplink and downlink time slot resources of the communication resource.

5. The method according to claim 2, wherein the length of the GP is ranged from a length of ⅔ of a sub-frame to a length of 2 sub-frames.

6. A device for processing a random access preamble, comprising:
a first determining component, configured to determine a Guard Time (GT) required by communication between a User Equipment (UE) and a base station according to a cell coverage radius, wherein the cell coverage radius is larger than 100 kilometers; and
a second determining component, configured to determine the random access preamble transmitted by the UE to the base station according to the GT, wherein the random access preamble is transmitted on an ordinary sub-frame in a radio frame during the communication between the UE and the base station.

7. The device according to claim 6, further comprising:
a third determining component, configured to determine a Guard Period (GP) required by the communication between the UE and the base station according to the cell coverage radius.

8. The device according to claim 6, wherein the second determining component comprises:
a regulating unit, configured to regulate lengths of a random access preamble sequence part and a GT part in the random access preamble of the radio frame, wherein a regulated length of the GT part is not smaller than that of the GT determined according to the cell coverage radius.

9. The device according to claim 6, further comprising:
a judging component, configured to judge whether a uplink time slot resource in a communication resource for the communication between the UE and the base station is sufficient for transmitting the random access preamble by the UE to the base station or not; and
a regulating component, configured to, based on that a judgment result of the judging component is negative, regulate the allocation of uplink and downlink time slot resources of the communication resource.

10. The device according to claim 7, wherein the third determining component is further configured to determine that the length of the GP is ranged from a length of ⅔ of a sub-frame to a length of 2 sub-frames.

11. The method according to claim 2, wherein determining the random access preamble transmitted by the UE to the base station according to the GT comprises:
regulating lengths of a random access preamble sequence part and a GT part in the random access preamble of the radio frame, wherein a regulated length of the GT part is not smaller than that of the GT determined according to the cell coverage radius.

12. The method according to claim 2, after determining the random access preamble transmitted by the UE to the base station according to the GT, further comprising:
judging whether a uplink time slot resource in a communication resource for the communication between the UE and the base station is sufficient for transmitting the random access preamble by the UE to the base station or not; and
based on that a judgment result is negative, regulating the allocation of uplink and downlink time slot resources of the communication resource.

13. The device according to claim 7, wherein the second determining component comprises:
a regulating unit, configured to regulate lengths of a random access preamble sequence part and a GT part in the random access preamble of the radio frame, wherein a regulated length of the GT part is not smaller than that of the GT determined according to the cell coverage radius.

14. The device according to claim 7, further comprising:
a judging component, configured to judge whether a uplink time slot resource in a communication resource for the communication between the UE and the base station is sufficient for transmitting the random access preamble by the UE to the base station or not; and
a regulating component, configured to, based on that a judgment result of the judging component is negative, regulate the allocation of uplink and downlink time slot resources of the communication resource.
